(19) United States
(12) Patent Application Publication
(10) Pub. No.: US 2013/0332859 A1
(43) Pub. Date: Dec. 12, 2013

(54) METHOD AND USER INTERFACE FOR CREATING AN ANIMATED COMMUNICATION

(71) Applicant: SRI International, Menlo Park, CA (US)

(72) Inventors: CHARLES M. PATTON, Eugene, OR (US); Jeremy Roschelle, Palo Alto, CA (US); John J. Brecht, San Francisco, CA (US); Kate S. Borelli, Aptos, CA (US)

(21) Appl. No.: 13/914,230

(22) Filed: Jun. 10, 2013

Related U.S. Application Data
(60) Provisional application No. 61/657,181, filed on Jun. 8, 2012.

(51) Int. Cl. G06F 3/0481

(52) U.S. Cl. CPC G06F 3/0481
USPC 715/753

(57) ABSTRACT

Creating an animated communication includes receiving from a user a series of inputs, wherein the series of inputs defines turns at expression to be taken by a plurality of avatars, wherein at least one of the turns comprises a plurality of expressive modalities that collectively forms a single turn, and wherein at least one of the turns makes use of a virtual writing surface that is shared by the avatars, and rendering the animated communication in accordance with the inputs subsequently to the receiving. Editing a document, such as an animated communication or a portion thereof, includes rendering the document as a sequence of dynamic frames, detecting an input made by a user during the rendering, identifying a dynamic frame of the sequence of dynamic frames whose time of rendering corresponds to a time of the input, and replacing at least a portion of the dynamic frame with the input.

### CROSS REFERENCE TO RELATED APPLICATIONS

This application claims the benefit of U.S. Provisional Patent Application Ser. No. 61/657,181, filed Jun. 8, 2012, which is herein incorporated by reference in its entirety.

### REFERENCE TO GOVERNMENT FUNDING

This invention was made with Government support under grant no. DRL-0918339, awarded by the National Science Foundation. The Government has certain rights in this invention.

### FIELD OF THE INVENTION

The present invention relates generally to dynamic content, and relates more particularly to the creation, storage, and distribution of animated communications.

### BACKGROUND OF THE DISCLOSURE

Increasingly, World Wide Web users are taking advantage of dynamic content to communicate with each other and to share knowledge. For example, popular web sites allow users to share video tutorials on a variety of subjects. These video tutorials are typically one-sided monologues in which a single individual lectures or performs a demonstration.

Great teachers throughout time have used two-sided dialogues to facilitate learning. That is, the interaction of the teacher and the student is used to convey knowledge more effectively. However, conventional tools for authoring dynamic content do not allow users to easily create or share compelling explanatory dialogues. Moreover, although a live-action dialogue can be created (e.g., in which real actors perform scripted or extemporaneous content), creation of attractive live-action dialogues requires relatively advanced skills at direction, production, and acting, as well as access to potentially expensive equipment.

### SUMMARY OF THE INVENTION

One embodiment of a method for creating an animated communication includes receiving from a user a series of inputs, wherein the series of inputs defines turns at expression to be taken by a plurality of avatars, wherein at least one of the turns at expression comprises a plurality of expressive modalities that collectively forms a single turn, and wherein at least one of the turns at expression makes use of a virtual writing surface that is shared by the avatars, and rendering the animated communication in accordance with the series of inputs subsequently to the receiving.

Another embodiment of a method for creating an animated communication includes receiving from a user a series of inputs, wherein the series of inputs defines at least: an utterance made by an avatar and a marking made by the avatar on a virtual writing surface, displaying the avatar and the virtual writing surface on a common display, rendering the utterance as displayed text and as an audible output, and rendering the marking as a time-ordered series of displayed strokes on the virtual writing surface.

One embodiment of a user interface for creating an animated communication includes a virtual writing surface through which a first type of input from a user is directly received, the first type of input defining an appearance of the virtual writing surface, and a plurality of avatars positioned adjacent to the virtual writing surface and through which a second type of input is directly received, the second type of input defining an appearance or gesture of one of the plurality of avatars.

One embodiment of a method for editing a document, such as an animated communication or a portion thereof, includes rendering the document as a sequence of dynamic frames, detecting an input made by a user during the rendering, identifying a dynamic frame of the sequence of dynamic frames whose time of rendering corresponds to a time of the input, and replacing at least a portion of the dynamic frame with the input.

### BRIEF DESCRIPTION OF THE DRAWINGS

The teachings of the present invention can be readily understood by considering the following detailed description in conjunction with the accompanying drawings, in which:

FIG. 1 is a schematic diagram illustrating one embodiment of a user interface for creating an animated communication, according to the present invention;

FIG. 2 is a flow diagram illustrating one embodiment of a method for creating an animated communication, according to the present invention;

FIG. 3 is a flow diagram illustrating one embodiment of a method for performance-based editing, according to the present invention;

FIGS. 4A-4B illustrate a portion of a document that is edited in accordance with the method illustrated in FIG. 3;

FIG. 5 illustrates an exemplary programmatic implementation of certain features of the performance-based editing method illustrated in FIG. 3; and

FIG. 6 is a high level block diagram of the present invention that is implemented using a general purpose computing device.

To facilitate understanding, identical reference numerals have sometimes been used to designate elements common to multiple figures.

### DETAILED DESCRIPTION

The present invention relates to a method and user interface for creating an animated communication. Embodiments of the invention create animated communications, under the direction of a user, that define an avatar interacting with a virtual writing surface (e.g., a virtual “whiteboard”). In one embodiment, multiple avatars interact with each other, using the virtual writing surface and explanatory dialogue. For instance, different avatars may be depicted to represent a teacher and a student. The interaction between the teacher and the student can then be defined through a temporal sequence of gestures, utterances, facial expressions, and/or demonstrations. Thus, the resultant animated dialogue coordinates scripted speech, whiteboard demonstrations, facial expressions, and gestures.

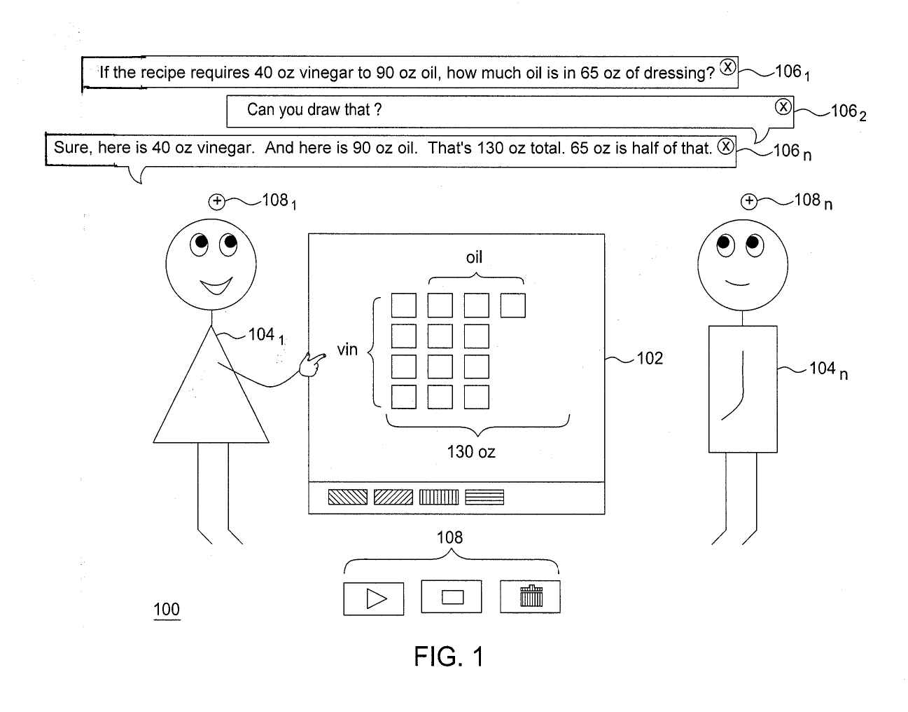

FIG. 1 is a schematic diagram illustrating one embodiment of a user interface 100 for creating an animated communication, according to the present invention. The user interface 100 may be displayed on an end user computing device, such as a desktop computer, a laptop computer, a tablet computer, a cellular telephone, a portable gaming device, a portable music player, an electronic book reader, or the like. The user interface 100 allows the user to access an executable program through which the user can create an animated communication. The executable program may run locally on the end user computing device or may run from a remote server that is accessed by the end user computing device (e.g. over a network).

In one embodiment, the user interface 100 generally comprises a virtual writing surface (e.g., a virtual “whiteboard”) 102 and at least one avatar 104₁-104ₙ (hereinafter collectively referred to as “avatars 104”) positioned adjacent to the virtual writing surface 102.

As discussed in further detail below, the appearance of the virtual writing surface 102 can be altered by the user. For instance, the user may create a demonstration using the virtual writing surface 102, by drawing an image or writing text on it (e.g., by typing text or inputting a physical motion such as a cursor movement or a finger trace on a touch screen). In one embodiment, a plurality of controls allows the user to select specific drawing tools (e.g., paintbrush, pencil, eraser, paint colors, etc.) with which to create a demonstration on the virtual writing surface 102. In another embodiment, an image or other file can be uploaded for display on the virtual writing surface 102.

Additionally, the appearances of the avatars 104 can be altered by the user. For instance, the user may select human characters or other anthropomorphic characters (e.g., animals). In addition, the user may select facial expressions for the avatars 104 from among a plurality of available expressions.

In one embodiment, the user interface 100 further includes at least one dialogue balloon 106₁-106ₙ (hereinafter collectively referred to as “dialogue balloons 106”) positioned proximate to a corresponding avatar 104. The dialogue balloons 106 allow the user to create an interaction between the virtual writing surface 102 and the avatar(s) 104. For instance, a control 108₁-108ₙ (hereinafter collectively referred to as “controls 108”) associated with each avatar 104 allows the user to generate a new dialogue balloon 106 for that avatar 104. Thus, dialogue balloons 106 may be selectively added to the user interface 100 by the user.

Using the dialogue balloon 106, the user can create a “turn” for the avatar 104. A “turn,” within the context of the present invention, refers to an instance of expression, which may include a contemporaneous (e.g., temporally indexed) set of actions including speech, facial expressions, gestures, and/or demonstrations. Thus, a single “turn” may include a plurality of expressive modalities that collectively form one instance of expression (e.g., speech and a related gesture or facial expression). For instance, when the dialogue balloon 106 for the avatar 104 is active (i.e., in a format ready for editing), the user can insert an utterance for the avatar 104 (e.g., by typing the text of the utterance into the speech balloon 106 or by creating an audible recording of the utterance using a microphone or transducer). In one embodiment, only one dialogue balloon 106 is active at a time. If no utterance is inserted in the dialogue balloon 106, then the “turn” may be silent (but may still include gestures, demonstrations, and/or facial expressions, as discussed below).

In addition, when the dialogue balloon 106 for the avatar 104 is active, the user can change the facial expression of the avatar 104 (e.g., by typing an emoticon into the dialogue balloon 106 or by toggling through a series of displayed facial expressions in the user interface 100).

In addition, when the dialogue balloon 106 for the avatar 104 is active, the user can create a gesture for the avatar 104 (e.g., via a stroke imposed on the portion of the avatar 104, such as a limb, that is doing the gesturing). In one embodiment, a plurality of controls (e.g., similar to the drawing controls for the virtual writing surface 102) allows the user to indicate when a gesture is being created.

In addition, when the dialogue balloon 106 for the avatar 104 is active, the user can create a demonstration (e.g., text, a drawing, a math problem, or the like) on the virtual writing surface 102 that will be linked to the avatar 104. The demonstration may comprise a completed visible article (e.g., text, drawing, etc.) or may comprise a timed series of ordered strokes that ultimately result in the visible article (in which case both the temporal sequence and the timing data for the strokes are stored). Each ordered stroke in the timed series of strokes may be thought of as a triplet (x, y, t), where x and y indicate a position in a coordinate space and t indicates an amount of time (e.g., in milliseconds) elapsed since recording of the series of strokes began. Alternatively, where the recording format corresponds to a time-ordered sequence of frames, each ordered stroke may be thought of as a five-tuple (x0, y0, x1, y1, n), where (x0, y0) indicates the position of the start of the stroke, (x1, y1) indicates the position of the end of the stroke, and n indicates the ordinal number of the frame.

In one embodiment, if a user pauses during the creation of a “turn” for an avatar 104, any content added after the pause is automatically appended to the content added before the pause, as long as the same dialogue balloon 106 is active. For instance, the user may draw a portion of a demonstration on the virtual writing surface 102 before pausing for an indeterminate period of time (perhaps even editing a different dialogue balloon 106 or exiting the application in the meantime), and then complete the demonstration after the pause. The portion of the demonstration added after the pause is automatically appended to the end of the time sequence associated with the portion of the demonstration added before the pause. The same technique can be applied to gestures. This eliminates the need for an explicit “record” feature in the user interface 100.

Thus, all utterances, gestures, facial expressions, and demonstrations that are created or edited when a given dialogue balloon 106 is active are stored for the given dialogue balloon 106. In one embodiment, playback of the utterances, gestures, facial expressions, and demonstrations that are stored for a common dialogue balloon 106 are each time-scaled so that they begin and end substantially contemporaneously when played back. For instance, drawing an image on the virtual writing surface 102 may take more time than typing an utterance into a dialogue balloon 106. However, when the animated communication is later played back, the action of drawing on the virtual writing surface 102 may be sped up to match the speed with which the utterance is spoken.

A series of dialogue balloons 106 can be created in this manner for different avatars (or even for a single avatar), thereby creating a linked temporal sequence of exchanged utterances, gestures, facial expressions, and drawings (i.e., a dialogue). For instance, dialogue balloons 106 may alternate between avatars 104 (although in some cases, two or more dialogue balloons 106 in a row may be associated with the same avatar 104). The series of dialogue balloons 106 can be scrolled if it becomes too long to be displayed in its entirety. The series of dialogue balloons 106 is later played back in order to illustrate the interaction between the virtual writing surface 102 and the avatar(s) 104.

Any given dialogue balloon 106 may be deleted (e.g., by clicking on a button on the dialogue balloon 106). Deletion of a dialogue balloon 106 will delete all utterances, gestures, facial expressions, and demonstrations that are linked to it. As discussed above, new dialogue balloons 106 can also be added by using the controls 108 associated with the avatars 104. In one embodiment, when the controls 108 are used to add a new dialogue balloon 106, the new dialogue balloon 106 is inserted directly after the currently active dialogue balloon 106 (e.g., instead of being inserted at the end of the series of dialogue balloons 106). Furthermore, any given “turn” will reflect the cumulative effects of all previous “turns,” including the addition and/or deletion of dialogue balloons 106. For instance, deleting or adding a dialogue balloon will delete or add associated elements of a demonstration on the virtual writing surface 102.

The user interface 100 may further include a set of playback controls 108. Playback controls 108 may include, for example, controls to automatically animate stored or in-progress communications (e.g., play, stop, pause, rewind, fast forward). The playback controls 108 may additionally include controls to delete stored or in-progress communications.

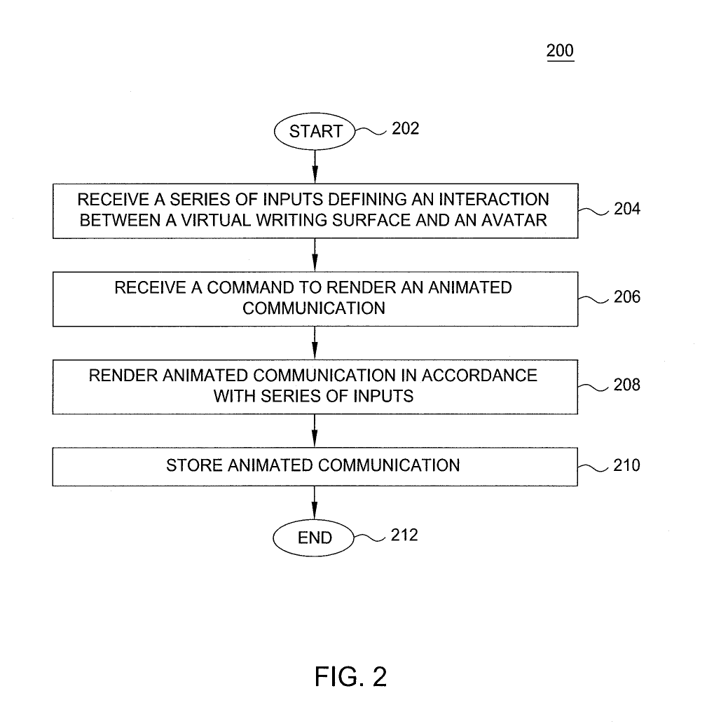

As discussed above, completed or in-progress communications that are created and edited using the user interface 100 can be stored and/or automatically animated. FIG. 2 is a flow diagram illustrating one embodiment of a method 200 for creating an animated communication, according to the present invention. In one embodiment, the method 200 is implemented in conjunction with the user interface 100 illustrated in FIG. 1; accordingly, and for explanatory purposes, reference is made in the discussion of the method 200 to various components of the user interface 100.

The method 200 begins in step 202. In step 204, a series of inputs defining an interaction between a virtual writing surface 102 and an avatar 104 is received from a user. In one embodiment, the series of inputs is received via the user interface 100 illustrated in FIG. 1. As discussed above, the series of inputs may include a linguistic input (e.g., an utterance to be made by an avatar 104, received through a text editing in a dialogue balloon 106 or though an audio recording), a physical motion input (e.g., a gesture or demonstration to be made by an avatar 104, received through a stroke embodied in a cursor movement or a finger trace on a touch screen), and/or other inputs that define different aspects of the interaction. Multiple inputs may be received independently of each other. Thus, the series of inputs may be embodied in a linked temporal sequence of dialogue balloons 106, where each of the dialogue balloons 106 in the sequence defines alterations to the virtual writing surface 102 (e.g., demonstrations that are illustrated on the virtual writing surface) and/or to the avatar 104 (e.g., facial expressions, gestures, utterances).

In step 206, a command to render the animated communication is received from a user (who may or may not be the same user from whom the series of inputs is received in step 204). As discussed above, the command may be received via a playback control 108 of the user interface 100.

In step 208, the animated communication is rendered in response to the command received in step 206. In one embodiment, rendering the animated communication includes rendering a textual input (e.g., as dynamic text, as a facial expression of an avatar 104, or as an audible utterance of an avatar 104), a stroke input (e.g., as a new marking or deletion of an existing marking on the virtual writing surface 102, as a zoom in or out on a portion of the virtual writing surface 102, as a new portion of the virtual writing surface 102, as a gesture of an avatar 104, as a motion of an object, or as a transformation of an object), and/or rendering other types of input. When stroke inputs are rendered, the marks that were made in the user interface 100 to specify gestures are not necessarily displayed; instead, the gestures indicated by the marks are displayed. When utterances are rendered, the utterances may include tones or inflections that convey an indicated emotion (e.g., indicated by use of images, emoticons, or text-based formatting).

In one embodiment, rendering the animated communication involves playing back the linked temporal sequence of dialogue balloons 106, in sequential order and including all associated utterances, gestures, facial expressions, and demonstrations. For instance, rendering may include visually animating a gesture of an avatar 104, visually displaying writing on the virtual writing surface 102, visually displaying a facial expression of the avatar 104, visually displaying an utterance in a dialogue balloon 106, and/or synthesizing or playing back an audio output corresponding to an utterance (e.g., using text-to-speech or voice recording technology). In a further embodiment, the text in the dialogue balloons 106 may be highlighted as the corresponding words are spoken (e.g., in a manner similar to karaoke lyrics). As discussed above, the rendering may further include time scaling the utterances, gestures, facial expressions, and/or demonstrations associated with a given dialogue balloon 106.

In one embodiment, there is a plurality of modes in which the animated communication may be rendered. In a first mode, the playback of the dialogue balloons 106 advances one dialogue balloon 106 per command. For instance, each time the user clicks his mouse, the animated communication advances one “turn” (including playing back all utterances, gestures, facial expressions, and demonstrations associated with that turn), resulting in an effect similar to clicking through successive frames of a slide show. In this first mode, editing of the animated communication may be temporarily disabled.

In a second mode, the playback of the dialogue balloons 106 progresses in sequence from start to finish, in response to a single command. Thus, unlike the first mode, the user does not need to enter a command to advance each dialogue balloon 106. Each “turn” is played in sequential order corresponding to the ordering of the dialogue balloons 106. In this second mode, editing of the animated communication may be temporarily disabled.

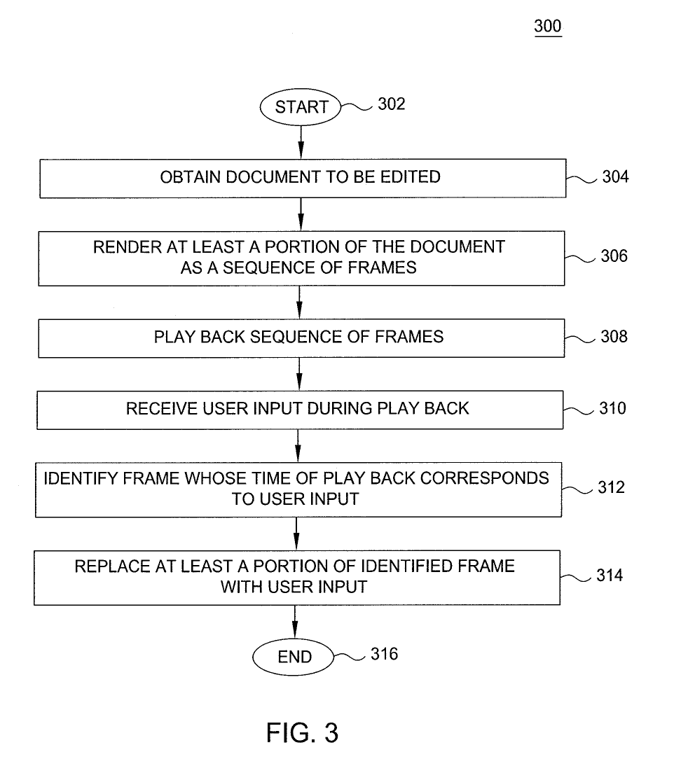

In a third mode, the playback of the dialogue balloons 106 progresses in sequence from start to finish, in response to a single command, but limited editing is temporarily enabled. In this case, any new inputs (edits) that are received during the playback of a given dialogue balloon 106 are stored with the dialogue balloon 106 just before the playback progresses to the next dialogue balloon 106. In one embodiment, editing in accordance with the third mode is performance-based. One embodiment of a method for performance-based editing is described in further detail in connection with FIG. 3.

Referring back to FIG. 2, in step 210, the animated communication is stored. This allows the animated communication to be accessed for future viewing and/or editing. The method 200 then ends in step 212.

Optionally, a new series of inputs including edits to the animated communication may be received from a user (who may or may not be the same user from whom the series of inputs is received in step 204) after completion of the method 200. Edits may include, for example, next text entered in a dialogue balloon 106, a re-recording of a recorded utterance, a re-drawn demonstration on the virtual writing surface 102, or the like. In this case, the method 200 implements the edits in the same manner described above (e.g., in connection with steps 204-210). However, as discussed above, editing capabilities may be temporarily disabled in whole or in part during certain modes of playback.

In a further embodiment, edits to an animated communication may comprise annotations made by different users (e.g., which may or may not include the user(s) who created the animated dialogue). In one embodiment, annotations are visibly distinguished from the original content of the animated communication (e.g., by presenting the annotations in a different color or font or in a different region of the display). In a further embodiment, annotations are linked to specific dialogue balloons 106 rather than to the animated communication as a whole.

As discussed above, editing of a “turn” in the animated communication may, in some cases, be performance-based. “Performance-based” editing leverages the human impulse to correct performances “in situ.” In this case, editing involves superimposing the “right” performance over the “wrong” performance. This approach provides a simple and intuitive means for editing non-traditional (e.g., dynamic) media.

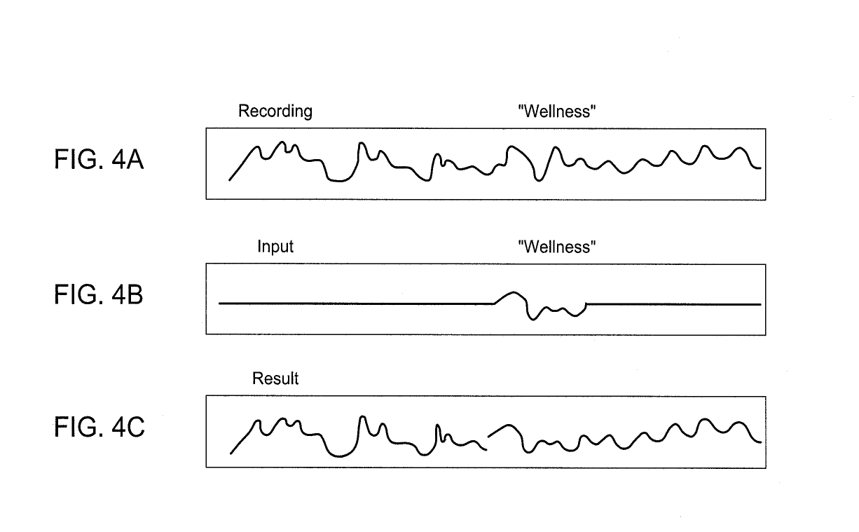

FIG. 3 is a flow diagram illustrating one embodiment of a method 300 for performance-based editing, according to the present invention. The method 300 may be implemented, for example, in accordance with step 204 of the method 200. Alternatively, the method 300 may be implemented as a standalone process for editing a document that may or may not have been created using the user interface 100. FIGS. 4A-4B illustrate a portion of a document that is edited in accordance with the method 300 illustrated in FIG. 3. Thus, reference may be made simultaneously to portions of FIG. 3 and FIGS. 4A-4C as indicated below.

The method 300 begins in step 302. In step 304, a document to be edited is obtained. For instance, the document to be edited may be a “turn” of an animated communication, or a specific portion of the “turn” (e.g., just the utterance). In other cases, however, the document may be a text document, an audio or video file, or any other type of document unrelated to an animated communication. In the former case, the user's desire to edit the turn may be indicated by selection of the dialogue balloon 106 associated with the turn. For illustrative purposes, it is assumed that the document to be edited is the utterance portion of a turn of an animated communication.

In step 306, the document (or the portion of the document to be edited) is rendered as a sequence of dynamic “frames.” These frames are units in which a predetermined action (e.g., the sounding of a word, the activation of pixels to illustrate a stroke) unfolds over time. For instance, if the document is an utterance, the audio file of the utterance (e.g., a human voice recording or a synthesized, text-to-speech file) is rendered as an ordered sequence of audio frames, where each frame contains a portion of the utterance (e.g., a single word or syllable). Alternatively, if the document is a text document, the text document may be converted, using text-to-speech technology, to a sequence of audio frames. In another embodiment still, each frame in the sequence could correspond to a time-indexed drawing stroke of a demonstration illustrated on the virtual writing surface 102 of the user interface 100 illustrated in FIG. 1.

In step 308, the sequence of frames is played back for the user. For instance, if the document is an utterance, then the sequence of audio frames representing the utterance is played audibly for the user, in sequential order. As an example FIG. 4A illustrates a portion of a sequence of audio frames that is played back in accordance with step 308.

In step 310, an input is received from the user during the playback of the sequence of frames. For instance, an audio input (e.g., a spoken word) may be received from the user. The input represents a user-provided replacement for the portion of the document (e.g., the frame) that was being played back at the time that the input was received. As an example, FIG. 4B illustrates an audio input that is received from a user during playback of the sequence of audio frames illustrated in FIG. 4A. As illustrated, the user has indicated that the word “wellness,” which is included in the sequence of audio frames illustrated in FIG. 4A, should be replaced with the word “wetness.”

In step 312, the frame whose time of playback corresponds to the input received in step 310 is identified. In one embodiment, the method 300 may account for some amount of delay in between the playback and the reception of the input (for instance, the user will probably not know that he wishes to replace what is in a frame until after that frame has been played back, so it is unlikely that he would provide his input at exactly the same moment that the frame is being played). In one embodiment, auxiliary information, such as a transcript, is provided to assist the user in determining the need for replacement prior to each frame ending.

In step 314, at least a portion of the frame identified in step 312 is replaced with the input received in step 310. In one embodiment, this step involves some additional processing in order to recognize the input that is replacing the original portion of the frame. For instance, if the input received in step 310 is a spoken utterance, speech recognition processing may be employed to recognize the words contained in the spoken utterance (i.e., the words that are to be inserted into the document). As an example, FIG. 4C illustrates the sequence of audio frames illustrated in FIG. 4A, modified to incorporate the audio input received in FIG. 4B. As illustrated, the word “wellness,” which is included in the sequence of audio frames illustrated in FIG. 4A, is replaced with the word “wetness,” which is received from the user in FIG. 4B.

The method 300 ends in step 316.

The method 300 requires no specialized hardware; it can be performed using the same end user computing device used in connection with the method 200. In one embodiment, however, the input and output devices of the end user computing device are physically proximal (e.g., as they would be on a touch screen device). Furthermore, a recording means of the end user computing device is segmented into a plurality of entry blocks or frames.

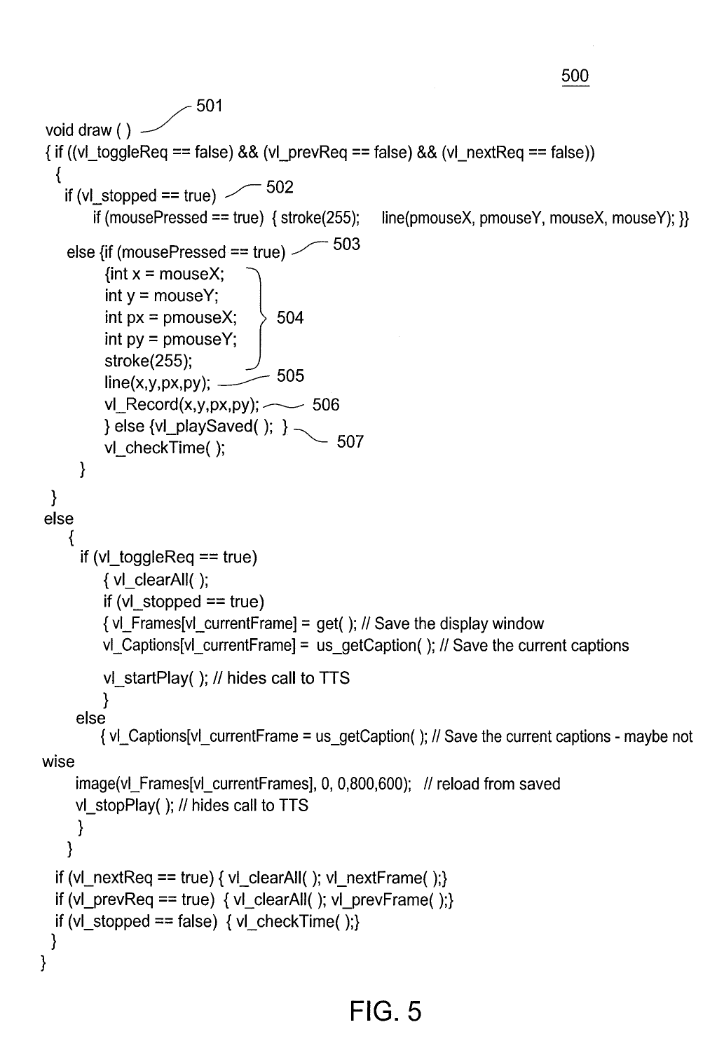

FIG. 5 illustrates an exemplary programmatic implementation of certain features of the performance-based editing method illustrated in FIG. 3. In particular, the programmatic implementation illustrated in FIG. 5 is implemented in the Processing.js idiom of the JAVASCRIPT programming language; however, other programming languages could be used to implement these features.

More specifically, in the illustrated idiom, the user interaction loop is defined by the function “draw( )” 501. A conditional statement 502 determines whether the playback is currently supposed to be paused or playing. If the playback is currently supposed to be playing, conditional statement 503 determines whether the user is attempting to provide input. If the user is not attempting to provide input, then what was previously recorded for the current frame is played back 507. If the user is attempting to provide input, then the input is captured 504 and (optionally) played as feedback to the user 505. The input is also stored 506 in place of what was previously recorded (if anything).

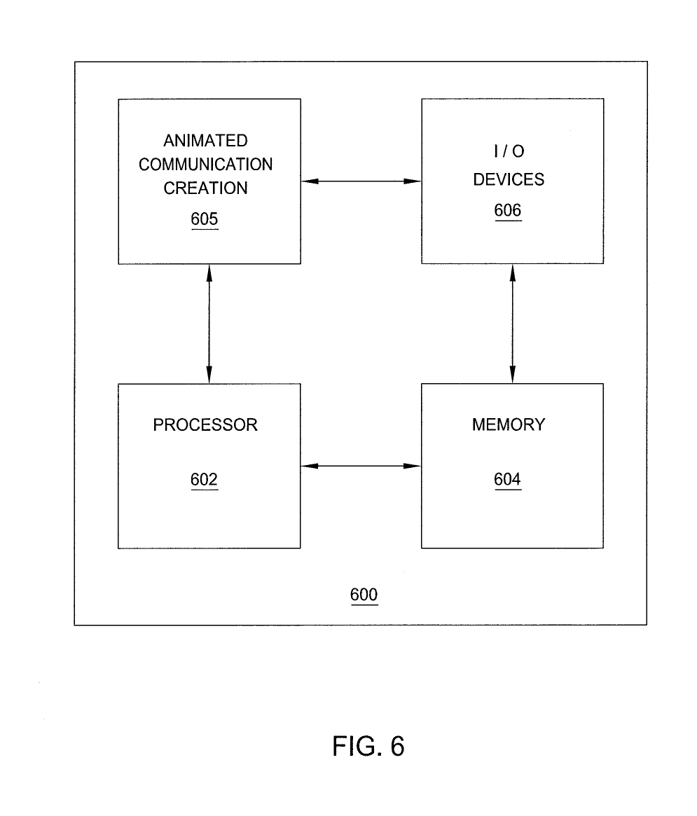

FIG. 6 is a high level block diagram of the present invention that is implemented using a general purpose computing device 600. The general purpose computing device 600 may, for example, generally comprise elements of an end user computing device configured to display the user interface 100 described above. In one embodiment, a general purpose computing device 600 comprises a processor 602, a memory 604, an animated communication creation module 605 and various input/output (I/O) devices 606 such as a display (which may or may not be a touch screen display), a keyboard, a mouse, a modem, a microphone, a transducer, and the like. In one embodiment, at least one I/O device is a storage device (e.g., a disk drive, an optical disk drive, a floppy disk drive). It should be understood that the animated communication creation module 605 can be implemented as a physical device or subsystem that is coupled to a processor through a communication channel.

Alternatively, the animated communication creation module 605 can be represented by one or more software applications (or even a combination of software and hardware, e.g., using Application Specific Integrated Circuits (ASIC)), where the software is loaded from a storage medium (e.g., I/O devices 606) and operated by the processor 602 in the memory 604 of the general purpose computing device 600. Thus, in one embodiment, the animated communication creation module 605 for creating animated communications described herein with reference to the preceding Figures can be stored on a non-transitory or tangible computer readable medium or carrier (e.g., RAM, magnetic or optical drive or diskette, and the like).

One or more steps of the methods described herein may include a storing, displaying and/or outputting step as required for a particular application, even if not explicitly specified herein. In other words, any data, records, fields, and/or intermediate results discussed in the methods can be stored, displayed, and/or output to another device as required for a particular application.

Although various embodiments which incorporate the teachings of the present invention have been shown and described in detail herein, those skilled in the art can readily devise many other varied embodiments that still incorporate these teachings.

What is claimed is:

1. A method for creating an animated communication, the method comprising:
receiving from a user a series of inputs, wherein the series of inputs defines turns at expression to be taken by a plurality of avatars, wherein at least one of the turns at expression comprises a plurality of expressive modalities that collectively forms a single turn, and wherein at least one of the turns at expression makes use of a virtual writing surface that is shared by the plurality of avatars; and
rendering the animated communication in accordance with the series of inputs subsequently to the receiving.

2. The method of claim 1, wherein the series of inputs comprises a linguistic input.

3. The method of claim 2, wherein the linguistic input comprises an utterance to be made by one of the plurality of avatars.

4. The method of claim 2, wherein the linguistic input is received through a text editing action via a user interface.

5. The method of claim 4, wherein the text editing action comprises an entry of text in a dialogue balloon displayed by the user interface.

6. The method of claim 2, wherein the linguistic input is received through an audio recording.

7. The method of claim 1, wherein the series of inputs comprises a physical motion input.

8. The method of claim 7, wherein the physical motion input is received through a stroke.

9. The method of claim 8, wherein the stroke is embodied in a movement of a cursor via a user interface.

10. The method of claim 8, wherein the stroke is embodied in a finger trace on a touch screen display.

11. The method of claim 1, wherein the series of inputs comprises a first input and a second input that are received independently of each other.

12. The method of claim 1, wherein the series of inputs comprises a first input and a second input that comprise different modalities of the plurality of expressive modalities.

13. The method of claim 1, wherein the rendering comprises:
rendering a textual input of the series of inputs as static text.

14. The method of claim 1, wherein the rendering comprises:
rendering a textual input of the series of inputs as dynamic text.

15. The method of claim 1, wherein the rendering comprises:
rendering a textual input of the series of inputs as facial expression of one of the plurality of avatars.

16. The method of claim 1, wherein the rendering comprises:
rendering a textual input of the series of inputs as an audible utterance of one of the plurality of avatars.

17. The method of claim 1, wherein the rendering comprises:
rendering a stroke input of the series of inputs as a marking on the virtual writing surface.

18. The method of claim 1, wherein the rendering comprises:
rendering a stroke input of the series of inputs as a deletion on the virtual writing surface.

19. The method of claim 1, wherein the rendering comprises:
rendering a stroke input of the series of inputs as an magnification of a portion of the virtual writing surface.

20. The method of claim 1, wherein the rendering comprises:
rendering a stroke input of the series of inputs as a shrinking of a portion of the virtual writing surface.

21. The method of claim 1, wherein the rendering comprises:
rendering a stroke input of the series of inputs as a new portion of the virtual writing surface.

22. The method of claim 1, wherein the rendering comprises:
rendering a stroke input of the series of inputs as a gesture of one of the plurality of avatars.

23. The method of claim 1, wherein the rendering comprises:
rendering a stroke input of the series of inputs as a motion of an object.

24. The method of claim 1, wherein the rendering comprises:
rendering a stroke input of the series of inputs as a transformation of an object.

25. The method of claim 1, wherein the rendering comprises:
displaying an uploaded image on the virtual writing surface.

26. The method of claim 1, wherein the rendering comprises:
playing back a first input of the series of inputs in a manner that is time-scaled to a rendering of a second input of the series of inputs.

27. The method of claim 1, wherein the rendering comprises:
rendering an input of the series of inputs as an output comprising a sequence of dynamic frames;
detecting a new input made by the user during playback of the output;
identifying a dynamic frame of the sequence of dynamic frames whose time of playback corresponds to a time of the detecting; and
replacing at least a portion of the dynamic frame with the new input.

28. A computer readable storage device containing an executable program for processing data streams, wherein when the program is executed, the program causes a processor to performs steps of:
receiving from a user a series of inputs, wherein the series of inputs defines turns at expression to be taken by a plurality of avatars, wherein at least one of the turns at expression comprises a plurality of expressive modalities that collectively forms a single turn, and wherein at least one of the turns at expression makes use of a virtual writing surface that is shared by the plurality of avatars; and
rendering the animated communication in accordance with the series of inputs subsequently to the receiving.

29. A user interface for creating an animated communication, the user interface comprising:
a virtual writing surface through which a first type of input from a user is directly received, the first type of input defining an appearance of the virtual writing surface; and
a plurality of avatars positioned adjacent to the virtual writing surface and through which a second type of input is directly received, the second type of input defining an appearance or gesture of one of the plurality of avatars.

30. The user interface of claim 29, further comprising:
a dialogue balloon positioned proximate to one of the plurality of avatars and through which a plurality of types of inputs, including the first type of input and the second type of input, are received, the plurality of inputs defining at least one of: an appearance of the virtual writing surface, an appearance of the one of the plurality of avatars, a gesture of the one of the plurality of avatars, or an utterance of the one of the plurality of avatars.

31. A method for editing a document, the method comprising:
rendering the document as a sequence of dynamic frames;
detecting an input made by a user during the rendering;
identifying a dynamic frame of the sequence of dynamic frames whose time of rendering corresponds to a time of the input; and
replacing at least a portion of the dynamic frame with the input.

32. A method for creating an animated communication, the method comprising:
receiving from a user a series of inputs, wherein the series of inputs defines at least: an utterance made by an avatar and a marking made by the avatar on a virtual writing surface;
displaying the avatar and the virtual writing surface on a common display;
rendering the utterance as displayed text and as an audible output; and
rendering the marking as a time-ordered series of displayed strokes on the virtual writing surface.
